(19) United States
(12) Patent Application Publication
(10) Pub. No.: US 2026/0208430 A1
(43) Pub. Date: Jul. 23, 2026

(54) STRETCHING UNIT

(71) Applicant: BRÜCKNER MASCHINENBAU GmbH, Siegsdorf (DE)

(72) Inventors: Hannes HACKSTEINER, Saalfelden (AT); Christian HUBER, Siegsdorf (DE)

(21) Appl. No.: 19/456,894

(22) Filed: Jan. 22, 2026

(30) Foreign Application Priority Data
Jan. 23, 2025 (DE) 10 2025 102 444.8

(51) Int. Cl. B29C 55/02; B29C 35/00; B29C 35/02; B29C 37/00

(52) U.S. Cl. CPC B29C 55/02; B29C 35/002; B29C 35/0288; B29C 37/00; B29C 2037/90

(57) ABSTRACT

A stretching unit for stretching a film including an oven, in which a region of travel is defined for the film and at least one temperature measuring apparatus including at least two measuring devices and one control unit. The measuring devices each have a line-shaped field of view and are configured to measure the temperature of the film in the field of view optically, and the fields of view define a measuring region in the region of the region of travel. The control unit is configured to determine a temperature profile that is based on temperatures measured in the measuring region, and the temperatures for the temperature profile have been measured by different ones of the measuring devices.

### CROSS REFERENCE TO RELATED APPLICATION

This application claims priority to German Patent Application Number DE 10 2025 102 444.8, filed Jan. 22, 2025, the entire contents of which is hereby incorporated by reference.

### FIELD OF DISCLOSURE

The disclosure relates to a stretching unit for stretching a film, and more specifically, to a transverse direction orienter and/or a simultaneous stretching unit.

### BACKGROUND

Stretching units are used in particular in the production of plastics films. Typically, the film to be stretched is moved in such units through an oven of the unit in a direction of travel by means of a film transport system. The film to be stretched is heated in the oven before the stretching process and also kept at a predetermined temperature in, during and after the stretching process. Subsequently, the stretched film is cooled in the oven.

It is extremely important in the production of films that the film has a predetermined temperature across its entire width in order to avoid defects or homogeneities that can occur as a result of temperature fluctuations or incorrect temperatures.

To this end, determining the temperature of the film outside of the oven directly after leaving the oven or at a cooler site within the oven optically by means of, for example, a pyrometer or measuring the air temperature within the oven in a punctiform manner is known. Determining the air temperature as an indirect measuring method is linked to uncertainties, and the optical measuring method only covers a small part of the film width.

### SUMMARY

Thus, it is provided a stretching unit that provides a temperature profile of the film within the oven.

The object is solved by means of a stretching unit for stretching a film, in particular a transverse direction orienter and/or a simultaneous stretching unit, comprising an oven in which a region of travel is defined for the film and at least one temperature measuring apparatus comprising at least two measuring devices and one control unit. The measuring devices each have a field of view and are configured to measure the temperature of objects in the field of view optically, wherein the fields of view are line-shaped in the region of the region of travel and define a measuring region. The control unit is configured to determine a temperature profile that is based on temperatures measured in the measuring region, wherein the temperatures have been measured by different ones of the measuring devices.

By using multiple optical measuring devices that are placed within the oven, it is possible to implement a direct and thus exact temperature measurement of the film within the oven. At the same time, the temperature profile is considerably enlarged as a result, and its meaningfulness is improved as the measured temperatures of different measuring devices are used.

The film can be drawn through the oven at high speeds, for example speeds of between 50 and 1,000 m/min, wherein precise measurements are possible despite these speeds due to the use of multiple measuring devices.

In particular, the measuring region has a longitudinal expansion, wherein the temperature profile indicates the progression of the temperature along the longitudinal expansion. For example, the longitudinal expansion corresponds to the transverse direction of the oven, i.e. to the horizontal direction transverse to the direction of travel of the film to be stretched.

“Line-shaped” is understood to mean in this context that the fields of view each have a longitudinal expansion that is considerably, for example by orders of magnitude, larger than its transverse expansion. The longitudinal expansion extends, for example, in the operating direction of the stretching unit, i.e. transverse to the direction of travel of the film.

The temperature profile covers, for example, the entire measuring region and/or also comprises regions outside the measuring region. For example, values of the temperature profile outside the measuring region can be approached by the control unit, such as through extrapolation.

In particularly, the temperature profile is based on measured temperatures of all measuring devices of one of temperature measuring apparatuses.

For example, the control unit only determines a single temperature profile per measurement period.

In particular, the control unit is also configured to output the temperature profile, for example on another component such as a plant control, and/or by means of a visual display unit.

The output of the determined temperature profile can occur on a visual display unit of the control unit or on a visual display unit remote from the control unit, such as a separate terminal of a visual display unit of the plant control or a mobile end device (e.g. smartphone, tablet or laptop).

In one aspect, the measuring devices are arranged above and below the region of travel, and/or the measuring devices are infrared cameras, linescanners and/or thermal imaging cameras. In this way, the measuring devices can detect the film particularly well and can use proven measuring methods.

In particular, the measuring devices are located in the oven.

For example, the measuring devices are what are termed linescanners, i.e. linescanning pyrometers or cameras, such as linescanners of the MP series from Fluke Process Instruments GmbH.

For particularly detailed measuring, the temperature profile and/or the measuring region can extend transverse to the direction of travel of the film along the region of travel and/or across the entire width of the region of travel.

The width of the region of travel corresponds to, for example, the width of the film, i.e. the expansion of the film transverse to the direction of travel.

In an embodiment, the fields of view of the measuring devices extend transverse to the direction of travel of the film along the region of travel and/or are parallel to each other, in particular they are situated on a common straight line. In this way, a large region of the film can be measured with as few measuring devices as possible.

To measure the film completely, the fields of view of the measuring devices can adjoin each other or partially overlap in the region of travel and/or the measuring region can be continuous.

In an embodiment, the oven comprises a main chamber through which the region of travel extends, in particular wherein the measuring devices are located in the main chamber. By means of the main chamber, the temperature in the oven can be kept extremely constant. There is a particularly space-saving construction if the measuring devices are located in the main chamber. Here, it is important that the measuring devices are designed for the temperatures prevailing in the main chamber, for example for temperatures above 180° C.

In a variant of the embodiment, the oven comprises a least one auxiliary chamber that is connected to the main chamber optically, wherein the measuring devices are located in said or in multiple ones of said at least one auxiliary chamber. In this way, the temperatures can be reduced in the environment of the measuring devices so that the thermal stress and the requirements on the measuring devices are reduced.

For example, the measuring devices are located entirely in the corresponding auxiliary chamber or partially in the corresponding auxiliary chamber or partially outside the oven. In the later case, the measuring devices can be connected electrically from outside of the oven simply.

Multiple auxiliary chambers may be provided, in particular as many auxiliary chambers as the measuring devices. For example, exactly one measuring device is located in each auxiliary chamber.

To keep the temperature in the auxiliary chamber low, the main chamber can comprise a wall in which at least one opening is formed that opens into a corresponding one of the auxiliary chambers, wherein the field of view of the measuring device located in the corresponding auxiliary chamber extends through the opening in the main chamber.

The wall is, for example, a roof or a base of the main chamber. The auxiliary chamber can be located accordingly above or below the main chamber.

To improve the thermal break between the main chamber and the corresponding auxiliary chamber further, the width and/or the length of the opening can be larger than the width or the length, respectively, of the field of view in the region of the opening, in particular the width and/or the length of the opening corresponds to the width or length, respectively, of the field of view in the region of the opening.

In an embodiment, the main chamber, in particular the wall, and/or the auxiliary chamber can be thermally insulated with respect to each other and/or towards the environment of the oven in order to reduce the temperature loss in the oven.

For example, insulating boards are provided on the wall, in particular between the main chamber and the auxiliary chamber.

In an embodiment, the oven is designed to generate at least one air seal for one of said at least one auxiliary chamber, wherein the air seal reduces or prevents the exchange of air between the main chamber and the corresponding auxiliary chamber, in particular wherein the air seal is located in the corresponding opening, within the main chamber covering the corresponding opening or within the auxiliary chamber covering the corresponding opening. By means of the air seal, the thermal break between the main chamber and the corresponding auxiliary chamber is improved further without influencing the measuring of the measuring devices.

For example, as many air seals are provided as the auxiliary chambers.

For example, the oven comprises an air outlet for generating the air seal for each of at least one air seal, wherein the air outlet opens into the corresponding opening, into the main chamber adjacent to the corresponding opening or into the auxiliary chamber adjacent to the corresponding opening. In this way, an air seal can be realised simply and reliably.

Alternatively or additionally, the opening can be closed by a glass pane. For example, the measuring device and/or the control unit is/are designed in such a way that the glass pane does not influence the measuring of the temperature in the measuring region negatively.

In an embodiment, a funnel is located in the main chamber, said funnel surrounding one of said at least one opening, extending from the corresponding wall, in which said at least one opening is provided, towards the region of travel, and widening towards the region of travel, in particular wherein the stretching unit comprises a fan that is designed to convey air into the interior of the funnel. By means of the funnel alone or enhanced by the fan, it is possible in this way to avoid contaminating the measuring device.

For particularly precise temperatures in the oven, the main chamber, in particular the wall, and/or the auxiliary chamber are insulated thermally in respect to each other and/or towards the environment of the oven.

In an embodiment, the temperature measuring apparatus comprises three, four or more measuring devices, thereby also enabling the precise determination of temperature profiles for wide films.

For example, the control unit is integrated into one of the measuring devices, is designed separately from the measuring devices, is a computer unit separate from the oven and/or is integrated into a plant control of the stretching unit, thereby making the temperature measuring apparatus compact, exposing the control unit to low thermal stresses and reducing the number of components.

For example, the computer unit designed as the control unit is spatially separate from the oven, a local or remote server or is realised on a local or remote server.

For particularly meaningful temperature measurements, the temperature measuring apparatus can be located at the entrance of the oven, at the exit of the oven, in a preheating zone of the oven, in particular at its end, in a stretching zone of the oven, in particular at its end, in an annealing zone of the oven, in particular at its start, in a neutral zone of the oven between the annealing zone and a cooling zone of the oven, and/or in the cooling zone.

The stretching unit can comprise multiple temperature measuring apparatuses comprising measuring devices at various sites of the oven, thereby making it possible to monitor the temperature of the film more exactly.

In an independent inventive aspect that is currently not part of the claimed disclosure, said one or more of the temperature measuring apparatuses comprise only one measuring device. The measuring device is located, as described previously, in an auxiliary chamber of the oven. The temperature profile is then based on the measured temperatures of this one measuring device. With this aspect, the aspects of the dependent claims can be combined.

Temperature measuring apparatuses comprising only one measuring device are provided for example in the regions of the oven before the stretching zone of the film, such as at the start and at the end of the preheating zone; however can also be used in other regions of the oven.

### BRIEF DESCRIPTION OF THE DRAWINGS

Additional features and advantages of the disclosure are found in the following description as well as the attached drawings to which reference is made. In the drawings:

FIG. 1 shows a stretching unit according to an embodiment of the disclosure in a schematic top view.

FIG. 2 shows a section through the stretching unit according to FIG. 1 along the line II-II of FIG. 1 extremely schematically.

FIG. 3 shows a section through the stretching unit according to FIG. 1 along the line III-III of FIG. 1 extremely schematically.

FIG. 4 shows an exemplary temperature profile that has been generated by means of one of the temperature measuring apparatuses of the stretching unit according to FIG. 1.

FIG. 5 shows a section corresponding to that of FIG. 2 of a stretching unit according to a second embodiment of the disclosure.

FIGS. 6 and 7 each show a temperature measuring apparatus of a third and fourth embodiment of the disclosure schematically.

FIG. 8 shows a section through a stretching unit according to a fifth embodiment of the disclosure extremely schematically.

FIG. 9 shows a further temperature measuring apparatus of the stretching unit in section extremely schematically.

FIG. 10 shows a part of a section through a stretching unit according to a sixth embodiment of the disclosure extremely schematically.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as "at least one of A, B, or C". The same holds true for listings with more than three items.

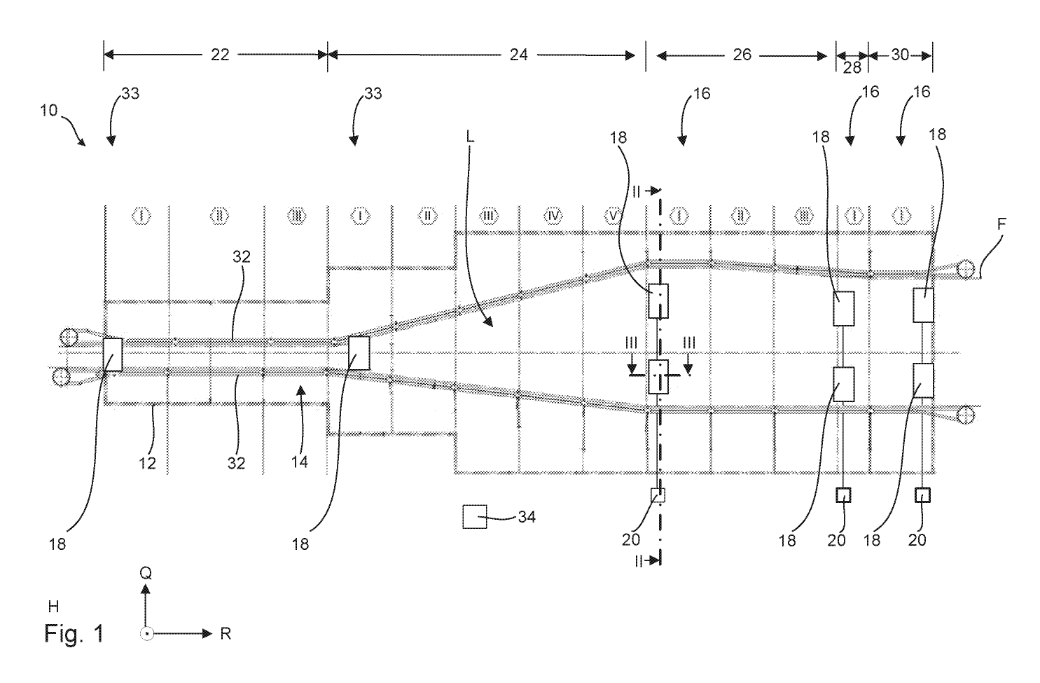

In FIG. 1, a stretching unit 10 according to the disclosure is shown extremely schematically.

In the shown first embodiment, the stretching unit is termed a transverse direction orienter (TDO). It is also conceivable that the stretching unit is a simultaneous stretching unit.

The stretching unit 10 comprises an oven 12, a film transport system 14 and at least one temperature measuring apparatus 16 each comprising multiple measuring devices 18 and a control unit 20.

The oven 12 has a drawing direction which corresponds to the direction of travel R of the film F to be stretched. The transverse direction Q of the oven 12 runs transversely to the direction of travel R and horizontally, and the vertical direction H runs vertically.

Along the direction of travel R, the oven 12 has different zones for the treatment of the film F to be stretched. The zones have partially different sections in which the temperature can be different.

The film F is heated in the first zone 22, also termed the preheating zone. The first zone 22 has, for example, three sections I-III.

In the subsequent second zone 24 (“stretching zone”) comprising five sections I-V, the film F is stretched in the transverse direction Q so that its width is greater at the end of the second zone 24 than it was at the start.

After completing the stretching, the film F then passes through the third zone 26 (termed “heat treatment zone”, “further heating zone” and/or “annealing zone”), in which a relaxation of the film F can take place at high temperatures. The third zone 26 has, for example, three sections I-III.

Subsequently, the film F passes through a fourth zone 28 and a fifth zone 30 (“cooling zone”), wherein the film F is cooled in the fifth zone 30. The cooling zone has, for example, one section I.

The fourth zone 28 is termed the neutral zone and separates the third zone 26 from the fifth zone 30. The neutral zone is, for example, an empty space without any ventilation. The neutral zone has, for example, one section I.

The zones of the stretching unit 10 can also be divided differently and/or designed differently in their lengths. For example, fewer or shorter neutral zones can be provided, or the neutral zones can be arranged at other sites, also additionally. Changes in the remaining zones are also conceivable.

The film transport system 14 comprises two transport rails 32 in the known manner which are arranged relative to a middle plane of the stretching unit 10 or the oven 12 mirror-symmetrically at a spacing and which extend at least in part in the oven 12.

In an entry zone as well as an exit zone, in which the film F of the stretching unit 10 is fed and removed, the transport rails 32 run outside of the oven 12.

The film F is gripped in the known manner by grippers (not shown) of the film transport system 14, which are guided along the transport rails 32, and is transported through the oven 12 in the direction of travel R.

In this way, a region of travel L is defined in the oven 12 by the transport rails 32, in said region of travel L the film F is transported through the oven 12.

The width of the region of travel L in the transverse direction Q, i.e. perpendicular to the direction of travel R and to the vertical direction H, is as wide as the film F.

The film F is drawn through the oven 12, for example, at high speeds, e.g. at speeds between 50 and 1,000 m/min.

For example, the oven 12, as in the shown embodiment, comprises three temperature measuring apparatuses 16 that have multiple measuring devices 18. It is also conceivable that the oven 12 only comprises one, two or more than three temperature measuring apparatuses 16.

For example, one of the temperature measuring apparatuses 16 is located in the first section of the third zone 26 (after the stretching zone, at the start of the annealing zone), i.e. at its start.

Another one of the temperature measuring apparatuses 16 is located, for example, in the fourth zone 28 (neutral zone), and the third temperature measuring apparatus 16 is located in the fifth zone 30 (cooling zone), in particular at its end. Thus, this temperature measuring apparatus 16 is located at the exit of the oven 12.

It is also conceivable that a single measuring device 33 is located in the first zone 22 (preheating zone), for example at the entrance of the oven 12 or in the last section of the preheating zone.

In the shown embodiment, temperature measuring apparatuses are provided at these sites, said temperature measuring apparatuses comprising only one measuring device 18. It is however also conceivable that these temperature measuring apparatuses 16 are such comprising multiple measuring devices 18.

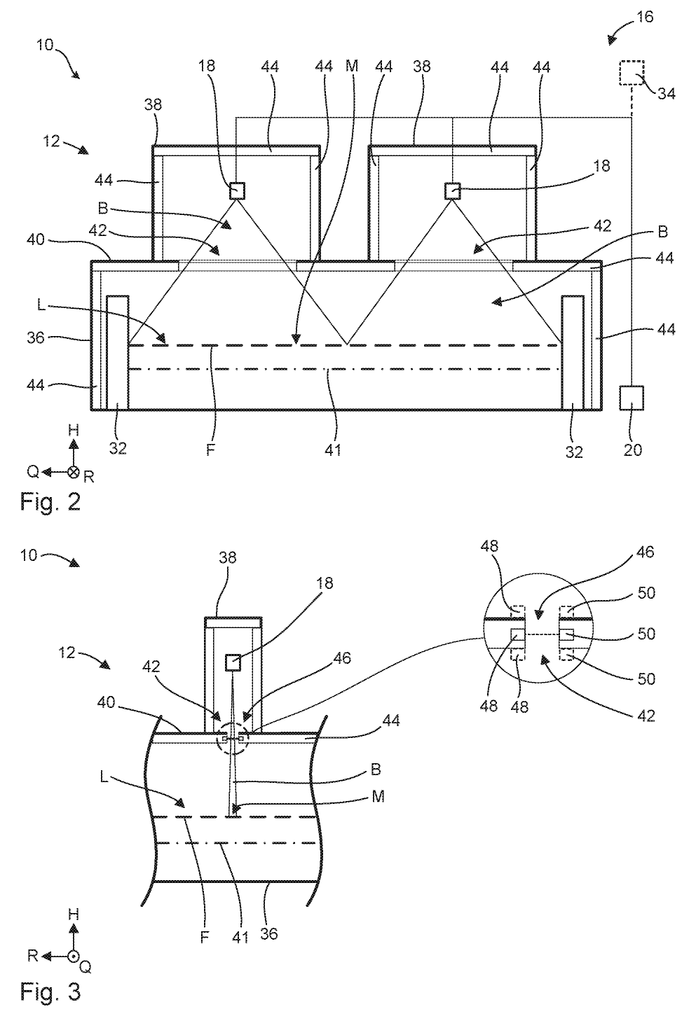

The FIGS. 2 and 3 show a longitudinal view and a cross section through the oven 12 in the region of one of the temperature measuring apparatuses 16.

It is clearly evident that the temperature measuring apparatus 16 comprises two measuring devices 18. It is also conceivable that the temperature measuring apparatus 16 comprises three, four or more measuring devices 18.

The control unit 20 is shown separately from the measuring devices 18 and is located outside the oven 12. It is also conceivable that the control unit 20 is integrated into one of the measuring devices 18, for example is a control unit of the measuring device 18 or is integrated into it. Similarly, it is conceivable that the control unit 20 is integrated into a superordinate plant control 34 of the stretching unit 10.

The oven 12 comprises a main chamber 36 and, for example, as in the shown example, multiple auxiliary chambers 38.

The main chamber 36 is delimited by a wall 40 that has for example a roof, a base and two side walls.

The film transport system 14 comprising the transport rails 32 and the region of travel L (shown with dashed lines) is located within the main chamber 36.

Furthermore, at least parts of heating devices, for example nozzle boxes (not shown), are located within the main chamber 36 in order to allow the heated air to flow in the region of travel L.

The measuring devices 18 are used for optical temperature measurements and are, for example, pyrometers or in particular infrared cameras or thermal imaging cameras. The measuring devices 18 are configured to measure the temperature of the objects in their field of view optically, for example using thermal radiation.

The fields of view B of the measuring devices 18 are here line-shaped, i.e. they have a longitudinal expansion that is considerably, for example by at least an order of magnitude, larger than its transverse expansion.

For this purpose, the measuring devices 18 are designed as line scan cameras or as scanners.

For example, the measuring devices 18 are linescanners of the MP series from Fluke Process Instruments GmbH.

The fields of view B are directed at the region of travel L, thereby making the part of the region of travel L, which is captured by one of the fields of view B of the measuring devices 18, a part of the measuring region M.

The line-shaped fields of view B and thus the measuring region M also extend in the transverse direction Q, i.e. transverse to the direction of travel R of the film F. The fields of view B are transverse to each other and are situated, for example, as in the shown embodiment, on a common straight line in the transverse direction Q.

The measuring devices 18 are placed in such a way that the fields of view B of neighbouring measuring devices 18 adjoin each other in the region of travel L, thereby making the measuring region M continuous.

To set the measuring region M, the measuring devices 18 are moveable within the auxiliary chamber 38, for example in the direction of travel L, the vertical direction H and/or the transverse direction Q.

The measuring devices 18 are located, for example, as in the shown embodiment, above the region of travel L. Accordingly, the auxiliary chambers 38 are positioned above the main chamber 36.

A reflector 41 (shown with dotted lines) can be located on the side of the measuring region M facing away from the measuring devices 18, in the shown embodiment thus below the region of travel L.

The reflector 41 covers, for example, at least one region that corresponds to the fields of view B of the measuring devices 18 of one or more temperature measuring apparatuses 16 at the height of the reflector 41. The reflector 41 thus forms a uniform closure of the field of view B of all measuring devices 18 of the same temperature measuring apparatus 18.

The reflector 41 is designed, for example, as a plate, for example as a 0.5 to 3 mm thick sheet which is orientated in particular horizontally.

Steel, galvanized steel, hot-dip aluminized steel, stainless steel or aluminium can be used as the material of the reflector 41.

The reflector 41 covers objects, such as crossmembers, that could influence the temperature measurements. Thus, a constant background temperature is attained for the temperature measurement.

One of the measuring devices 18 is provided in each of the auxiliary chambers 38 so that the same number of auxiliary chambers 38 are present as measuring devices 18 in the temperature measuring apparatus 16. In the shown embodiment, two auxiliary chambers 38 are thus provided in each of which exactly one measuring device 18 is attached.

In the following, an auxiliary chamber 38 is described in detail, wherein the other auxiliary chambers 38 are designed identically.

An opening 42 that opens into the corresponding auxiliary chamber 38 is formed in the wall 40 between the main chamber 36 and the auxiliary chamber 38, in the shown embodiment thus in the roof.

Thus, the main chamber 36 and the auxiliary chamber 38are optically connected to each other through the opening 42, and the measuring device 18 is arranged in such a way that its field of view B extends through the opening 42 into the main chamber 36.

The opening 42 is, for example, rectangular, in particular slotted or line-shaped, wherein the length of the opening 42 corresponds to the length of the field of view B in the region of the opening, i.e. at the height in the vertical direction H of the opening. The width of the opening 42 also corresponds to the width of the field of view B in the region of the opening 42.

The opening 42 also extends in the transverse direction Q, just like the field of view B.

In this way, the exchange of air between the main chamber 36 and the auxiliary chamber 38 is reduced to a minimum in order to keep the temperature in the auxiliary chamber 38 as low as possible and to minimise heat loss from the main chamber 36.

For insulation, the wall 40 of the main chamber 36 and the wall of the auxiliary chamber 38 are insulated towards the environment of the oven 12, for example by means of insulating boards 44 that are attached to the wall 40.

Thermal insulation, in particular insulating boards, is also formed between the main chamber 36 and the auxiliary chamber 38 in order to keep the temperature in the auxiliary chamber 38 as low as possible and to minimise heat loss from the main chamber 36.

The opening 42 also extends accordingly through the thermal insulation, for example the insulating board 44.

It is conceivable that multiple measuring devices 18 are located in one of the auxiliary chambers 38. In doing so, a separate opening 42 may be provided for each measuring device 18 and the field of view B of each measuring device 18, or the fields of view B of the measuring devices 18 in an auxiliary chamber 38 extend through the same opening 42.

For example, in this case, one or more partitions can be arranged between the measuring devices 18 in the auxiliary chamber 38.

It is also possible that all measuring devices 18 are located only in one auxiliary chamber 38.

It is also conceivable that the measuring devices 18 are located below the region of travel L so that then the auxiliary chamber 38 is located in this case below the main chamber 36.

For example, as in the shown embodiment, the oven 12 can comprise an air seal in addition to each of the auxiliary chambers 38. For example, an air outlet 48 is located in the opening 42, said air outlet 48 being directed into the opening 42. The air outlet 48 is connected fluidly, for example, to a compressed air source or an air supply system of the stretching unit 10.

The air outlet 48 extends here across the entire side of the opening 42, on which it is provided. For example, the air outlet 48 is realised by means of a perforated connecting pipe that extends in particular across the entire length of the opening 42.

In the shown embodiment, the air outlet 48 is located in one of the longitudinal sides of the opening 42 so that air flow is generated in or counter to the direction of travel R of the film F.

In addition, an air vent 50 can be provided opposite to the air outlet 48, with air of the air outlet 48 flowing against the air vent 50 in order to avoid turbulences in the main chamber 36 that could impact the quality of the film negatively. By means of the air discharge 50, air can be actively extracted so that no excess cold air enters into the oven.

During operation, air flows through the air outlet 48 to the air vent 50, thereby generating an air seal 46 in the entire opening 42 that prevents or at least reduces an exchange of air between the auxiliary chamber 38 and the main chamber 36.

In particular, such an air seal 46 and corresponding air outlets 48 are provided for each of the auxiliary chambers 38.

It is also conceivable that the air seal 46 and the air outlet 48 as well as the optional air vent 50 are located within the main chamber 36 or within the auxiliary chamber 38 adjacent to the opening 42 so that the corresponding air seal 46 reliably covers the relevant opening 42 (indicated as dashed lines in the enlargement of FIG. 3).

It is also conceivable that the opening 42 is closed alternatively or additionally by a pane, for example a glass pane, in order to prevent an exchange of air between the main chamber 36 and the auxiliary chamber 38. Here, the pane is permeable for thermal radiation of the film F, and the measuring device 18 and/or the control unit 20 are designed in such a way that the measurement values potentially changed by the pane do not negatively impact the measuring of the temperature in the measuring region M. For example, to this effect, the measuring devices 18 and/or the control unit 20 are calibrated.

In addition, the fields of view B also cover the edges in the transverse direction of the region of travel L so that the measuring region M extends across the entire width of the region of travel L and thus the film F.

During operation of the stretching unit 10, the measuring devices 18 measure the temperature of objects in their field of view B. During operation of the stretching unit 10, this is the film F that is guided into the region of travel L.

The measuring devices 18 thus determine the temperature of the film F in the part of the measuring region M that is formed by its field of view B. The measured temperatures, i.e. the measured values determined by the measuring devices 18, are transmitted to the control unit 20.

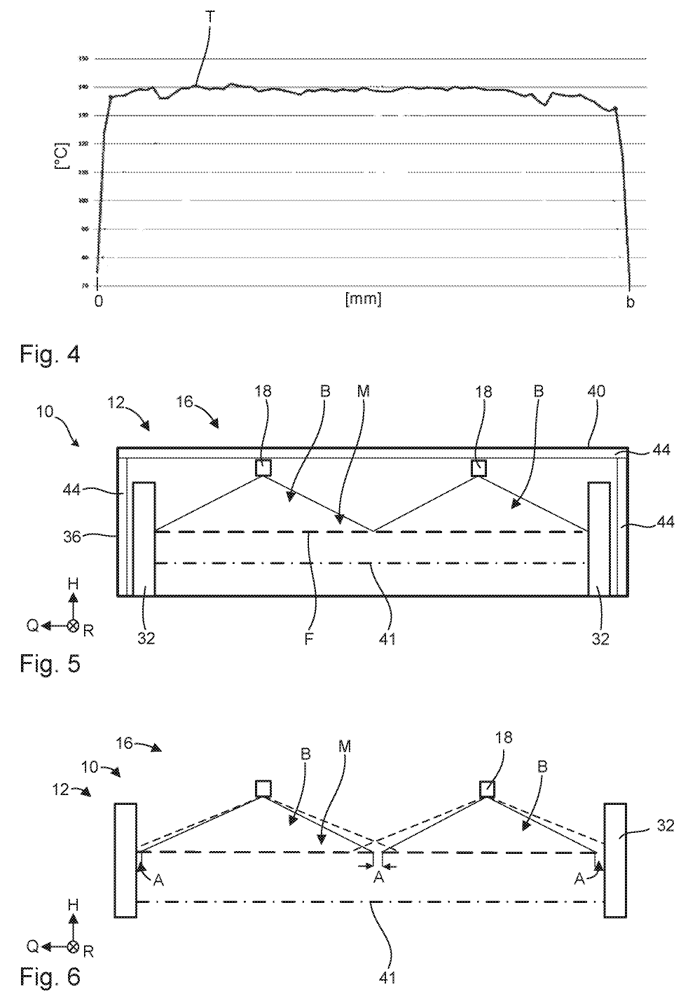

The control unit determines a temperature profile T, as shown exemplary in FIG. 4, which is based on the received measured values and thus on the measured temperatures of the measuring devices 18. Here, the temperature profile T is based on the measured temperatures of different measuring devices 18, in particular all measuring devices 18 of the corresponding temperature measuring apparatus 16, and is a continuous temperature profile T that reproduces the temperature variation of the film F across the entire width of the film F.

In doing so, the control unit 20 generates per measurement period a temperature profile T based on the values of the different measuring devices 18.

The temperature profile T reproduces the temperature variation in the direction of the longitudinal expansion of the measuring region M that corresponds in the shown embodiment to the transverse direction Q.

The temperature profile T covers here at least the entire measuring region M and depicts accordingly the temperature variation across the entire width of the region of travel L and thus the film F.

The temperature profile T is subsequently outputted by the control unit 20, for example it is transmitted to the plant control 34. An operator or an automatic control of the plant control 34 can then adjust, for example, parameters of the stretching unit 10, for example, the temperatures of individual sections of the zones 22-30.

The temperature profile T can be outputted, for example for the operator, on a visual display unit of the control unit or on a visual display unit remote from the control unit, such as a separate terminal, a visual display unit of the plant control or a mobile end device (e.g. smartphone, tablet or laptop).

Here, the temperature profile T can be a still image, which is updated manually or regularly, or a real-time image if the temperature measurement occurs continuously.

In FIG. 4, a temperature profile T that has been obtained from the measured temperatures of different measuring devices 18 is shown exemplarily. On the X-axis, the diagram extends between 0 mm, which represents the start of the film F or the region of travel L, to b, which corresponds to the width of the region of travel L or the film F. For example, b is 14 000 mm.

It is clearly evident that a single temperature curve is present in the temperature profile T although the temperatures between 0 and b have been determined by different measuring devices 18.

In a simple manner, it is thus possible by means of the disclosure to obtain a continuous temperature profile T that covers the entire width of the film F coherently, wherein the measurement occurs in the oven 12. In this way, the oven 12 can be set particularly precisely and the quality of the film F produced can be improved considerably.

The FIGS. 5-10 show further aspects of the disclosure that substantially correspond to the first embodiment. Therefore, only the differences are discussed hereinafter and the same parts and parts with the same function are provided with the same reference signs.

Although reference is only made to the first embodiment, all the features of the various other embodiments are also combinable with each other.

The second embodiment that is shown schematically in FIG. 5 differs from the first embodiment in that the measuring devices 18 are located within the main chamber 36. As a result, it is possible to dispense with the auxiliary chambers 38.

The measuring devices 18 are to be selected in such a way that their maximum operating temperature exceeds the maximum operating temperature of the oven 12.

In FIG. 6, a third embodiment is shown, wherein details regarding the oven 12 have been excluded for the sake of clarity. The measuring devices 18 can thus be arranged within the main chamber 36 according to the second embodiment or within the auxiliary chambers 38 according to the first embodiment.

In this third embodiment, the fields of view B do not adjoin each other, but rather have a spacing A in the region of travel L to each other. In addition, a spacing A is present on both sides between the edge of the field of view B and the edge of the region of travel L and the film F.

The measuring region M is thus no longer continuous and no longer covers the entire region of travel L and the entire film F:

The control unit 20 can be designed in such a way that it determines and outputs a single temperature profile T which also comprises regions outside the measuring region M. For example, the control unit 20 calculates values for the temperature in the regions of the spacings A on the basis of the measured temperature and can determine and output in this way a temperature profile T comprising the entire region of travel L and the entire film F in its width.

It is also conceivable that the fields of view B of the measuring devices 18 overlap each other, as indicated by the dashed lines in FIG. 6. In this way, the control unit 20 can adjust the measured temperatures of the measuring devices 18 to each other, i.e. calibrate the measuring devices 18 to each other, as a result of the doubled measured temperatures in the region of the overlap. The region of the overlap is only shown once in the temperature profile T—although measured twice—so that this temperature profile T corresponds to the measured film.

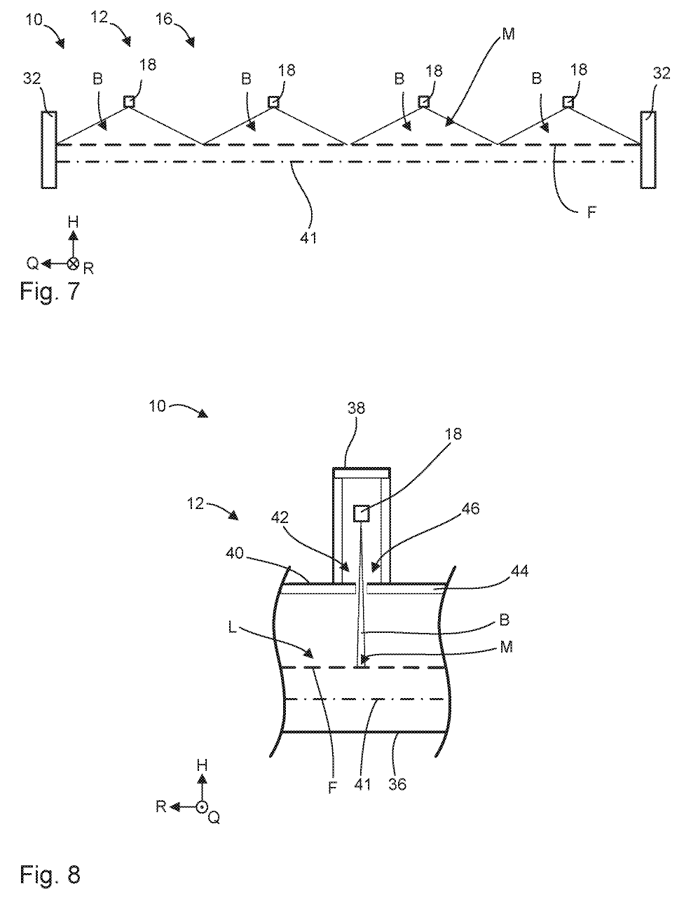

In FIG. 7, a fourth embodiment of the disclosure is shown. In contrast to the preceding embodiments, the temperature measuring apparatus 16 now comprises four measuring devices 18. For example, temperature profiles T for films F having a width of up to 14 000 mm can also be determined by means of four measuring devices 18, wherein the measuring region M is continuous or overlapping.

In FIG. 8, a fifth embodiment of disclosure is shown in a sectional view that corresponds to the view of FIG. 3.

In contrast to the first embodiment, no air seal is provided in this embodiment in or at the openings 42.

In an independent inventive aspect that is currently not part of the claimed disclosure, the temperature measuring apparatus 16 comprises only one measuring device 18. The measuring device 18 is located, as described previously, in an auxiliary chamber 38 of the oven 12. The temperature profile T is then based on the measured temperatures of this one measuring device 18.

In particular, the oven 12 comprises only one single auxiliary chamber 38 in the region of this temperature measuring apparatus 16.

By means of such a temperature measuring apparatus 16, the temperature of a certain region of the film F can be determined or the temperature profile of the film F can be determined along the width of the entire film F before stretching.

In other respects, the stretching unit 10 can be designed as described previously.

It is conceivable that the stretching unit 10 comprises multiple temperature measuring apparatuses 16, wherein at least one of the temperature measuring apparatuses 16 has multiple measuring devices 18 and at least another one of the temperature measuring apparatuses 16 only has one measuring device 18.

For example, the temperature measuring apparatuses 33 shown in FIG. 1 can be temperature measuring apparatuses 33 comprising only one measuring device 18.

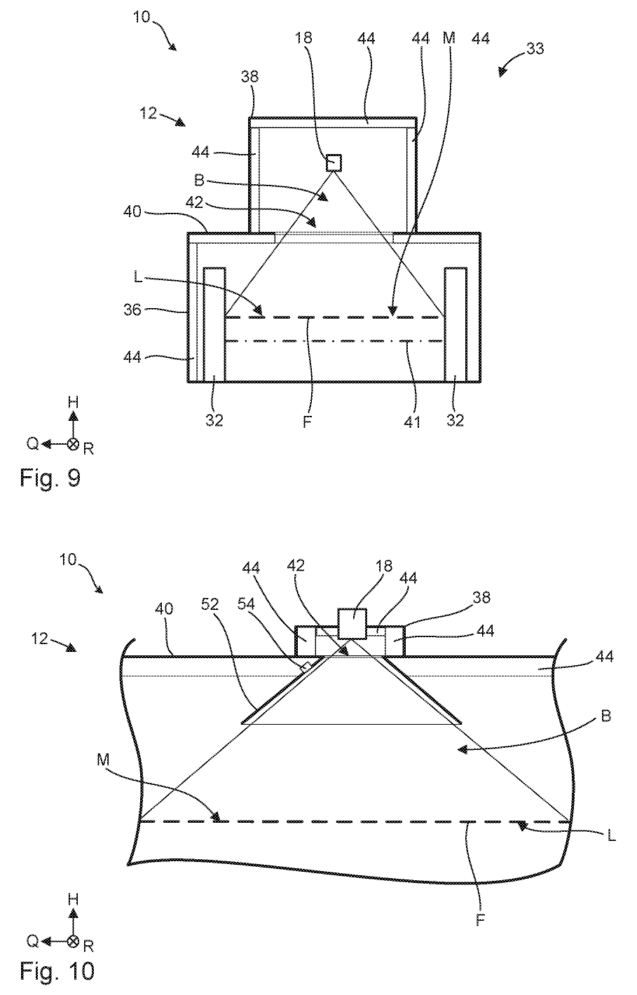

The temperature measuring apparatuses 33 comprising only one measuring device 18 are provided, for example, in regions of the oven 12 before the stretching zone of the film F, such as at the start and at end of the preheating zone. A section, corresponding to that of FIG. 2, through such a temperature measuring apparatus 33 comprising exactly one measuring device 18 is shown in FIG. 9.

The stretching unit 10 can thus comprise temperature measuring apparatuses 16 at each point in the direction of travel R so that a temperature measurement of the film F can be realised at every point.

In FIG. 10, a sixth embodiment of the stretching unit 10 is shown schematically in section which corresponds to the section of FIG. 2, wherein only one temperature measuring apparatus 16 is shown.

In this embodiment, the measuring device 18 is located partially within the auxiliary chamber 38 and partially outside. The measuring device 18 thus extends through the insulating board 44, in particular on the roof of the auxiliary chamber 38.

The optical entrance of the measuring device 18, for example the lens, is located within the auxiliary chamber 38 so that the field of view B of the measuring device 18 corresponds to the field of view of the embodiment described previously.

However, the rear side and the electrical connections of the measuring device 18 are located outside the auxiliary chamber 38 so that the connections of the measuring device 18 are accessible externally.

Another difference from the preceding embodiments, which is however partially outside the auxiliary chamber 38 irrespective of the position of the measuring device 18, is that a funnel 52 is provided around the opening 42.

The funnel 52 extends from the corresponding wall 40 of the main chamber 36, in the shown embodiment the roof, towards the region of travel L and ends spaced apart from the region of travel L. For example, the funnel 52 is attached to the wall 40 of the main chamber 36.

The funnel 52 opens towards the region of travel L, in particular to the same extent as the field of view B of the measuring device 18 opens towards the region of travel L.

The opening width of the funnel 52 in the transverse direction Q and the direction of travel R always corresponds to the expansion of the field of view B in the transverse direction Q and the direction of travel R. For example, the opening width of the funnel 52 is larger than the field of view B.

It is also conceivable that the stretching unit 10 comprises a fan 54 whose air outlet is fluidly connected to the interior of the funnel 52. In FIG. 10, the fan is attached directly to the funnel 52. However, it is also conceivable that the fan 54 is provided at another site and a duct, such as a tube, starting from the fan 54 runs to the funnel 52.

The fan 54 can derive its supply air from the main chamber 36. It is however conceivable that the supply air of the fan 54 is air from the auxiliary chamber 38 or is fresh air, thereby influencing however the temperature in the oven 12.

During operation, the fan 54 conveys air into the interior of the funnel 52 so that an air flow forms out of the funnel 52 towards the region of travel L. In this way, evaporations from the film F or other materials that could contaminate the lens of the measuring device 18, are prevented from reaching the measuring device 18. In addition, a thermal break is attained.

An air seal 46 is not necessary when using a fan 54.

1. A stretching unit for stretching a film, comprising:
an oven in which a region of travel is defined for the film and at least one temperature measuring apparatus comprising at least two measuring devices and one control unit,
wherein the measuring devices each have a field of view and are configured to measure the temperature of the film in the field of view optically, wherein the fields of view are line-shaped in the region of the region of travel and define a measuring region,
wherein the control unit is configured to determine a temperature profile that is based on temperatures measured in the measuring region, wherein the temperatures for the temperature profile have been measured by different ones of the measuring devices.

2. The stretching unit according to claim 1, wherein at least one of the measuring devices are located above or below the region of travel, or the measuring devices are at least one of infrared cameras, linescanners or thermal imaging cameras.

3. The stretching unit according to claim 1, wherein at least one of the temperature profile or the measuring region extends at least one of transverse to the direction of travel of the film along the region of travel or across the entire width of the region of travel.

4. The stretching unit according to claim 1, wherein the fields of view of the measuring devices extend at least one of transverse to the direction of travel of the film along the region of travel or are parallel to each other.

5. The stretching unit according to claim 4, wherein the fields of view of the measuring devices are situated on a common straight line.

6. The stretching unit according to claim 1, wherein at least one of the fields of view of the measuring devices adjoin each other or partially overlap in the region of travel, or the measuring region is continuous.

7. The stretching unit according to claim 1, wherein the oven comprises a main chamber, through which the region of travel extends.

8. The stretching unit according to claim 7, wherein the measuring devices are located in the main chamber.

9. The stretching unit according to claim 7, wherein the oven comprises at least one auxiliary chamber that is connected to the main chamber optically, wherein the measuring devices are located in said or multiple ones of the at least one auxiliary chamber.

10. The stretching unit according to claim 9, wherein the measuring devices are located completely in the corresponding auxiliary chamber or partially in the corresponding auxiliary chamber and partially outside the oven.

11. The stretching unit according to claim 10, wherein the main chamber comprises a wall in which at least one opening is formed that opens into a corresponding one of the auxiliary chambers, wherein the field of view of the measuring device located in the corresponding auxiliary chamber extends through the opening into the main chamber.

12. The stretching unit according to claim 11, wherein the at least one of width or the length of the opening is larger than the width or length, respectively, of the field of view in the region of the opening, or corresponds to the width or length, respectively, of the field of view in the region of the opening.

13. The stretching unit according to claim 9, wherein the oven is designed to generate at least one air seal for one of said at least one auxiliary chamber, wherein the air seal reduces or prevents an exchange of air between the main chamber and the corresponding auxiliary chamber.

14. The stretching unit according to claim 13, wherein the air seal is located in the corresponding opening, within the main chamber covering the corresponding opening or within the auxiliary chamber covering the corresponding opening.

15. The stretching unit according to claim 14, wherein the oven comprises an air outlet for generating the air seal for each of said at least one air seal, wherein the air outlet opens into the corresponding opening, in the main chamber adjacent to the corresponding opening or in the auxiliary chamber adjacent to the corresponding opening.

16. The stretching unit according to claim 11, wherein a funnel is located in the main chamber, said funnel surrounding one of said at least one opening, extending from the corresponding wall, in which said at least one opening is provided, towards the region of travel and widening towards the region of travel.

17. The stretching unit according to claim 16, wherein the stretching unit comprises a fan that is designed to convey air into the interior of the funnel.

18. The stretching unit according to claim 7, wherein at least one of the main chamber or the auxiliary chamber are insulated thermally at least one of in respect to each other or towards the environment of the oven.

19. The stretching unit according to claim 1, wherein at least one of the temperature measuring apparatus comprises three, four or multiple measuring devices, or the control unit is at least one of integrated into one of the measuring devices, is separate from the measuring devices, is a computer unit separate from the oven, or is integrated into a plant control of the stretching unit.

20. The stretching unit according to claim 1, wherein at least one of the temperature measuring apparatus is located at least one of at the entrance of the oven, at the exit of the oven, in a preheating zone of the oven, in a stretching zone of the oven, in an annealing zone of the oven, in a neutral zone of the oven between the annealing zone and a cooling zone of the oven, or in the cooling zone; or that the stretching unit comprises multiple temperature measuring apparatuses.
